(19) United States
(12) Patent Application Publication
(10) Pub. No.: US 2009/0289440 A1
(43) Pub. Date: Nov. 26, 2009

(54) DUAL INDEPENDENT SIDE-BY-SIDE STROLLER

(76) Inventors: Shad Harry Besikof, Newport Beach, CA (US); Sarah Matalie Besikof, Newport Beach, CA (US)

Correspondence Address: CHARLES C.H. WU, 98 DISCOVERY, IRVINE, CA, 92618-3105, US

(21) Appl. No.: 12/470,831

(22) Filed: May 22, 2009

Related U.S. Application Data
(60) Provisional application No. 61/055,732, filed on May 23, 2008.

(51) Int. Cl. B62B 7/12; B23P 19/00

(52) U.S. Cl. 280/643; 29/426.5

(57) ABSTRACT

A stroller formed by connecting a plurality of independent strollers for transporting at least one occupant. The stroller comprises a plurality of tubular frames, a plurality of seats, a wheel assembly, at least one attachment means and a plurality of levers. The attachment means is fixed at an opposing left and right sides of the plurality of tubular frames. The plurality of levers is pulled simultaneously to detach the attachment means thereby separating the plurality of independent strollers. The plurality of tubular frames is attached with each other by pushing the plurality of independent strollers and aligning the at least one attachment means to define a central frame portion to form a dual independent side-by-side stroller. The plurality of sets of folding and/or unfolding wheels retract when the plurality of independent strollers are connected and extends when the plurality of independent strollers are disconnected.

This application claims the benefit of U.S. Provisional Application No. 61/055,732 filed May 23, 2008.

### BACKGROUND OF THE INVENTION

1. Technical Field of the Invention

The present invention relates in general to an infant/toddler stroller. More specifically, the present invention relates to a stroller having a locking mechanism that allows two independent strollers to attach to form a single side-by-side dual independent stroller and unlock to form two independent folding and/or unfolding strollers.

2. Description of the Related Art

Strollers for infants and small children are widely used as a means for enhancing the safety and comfort of small children, while increasing the convenience of adults. The strollers are often desirable to carry the infant along while engaging in running or jogging activities by the adults. Various strollers are devised for convenience of adults such as standard strollers, lightweight strollers, multi child strollers and the like.

Many parents with multiple children have two or more single strollers, but it is cumbersome for one person to safely push and control multiple single strollers simultaneously. In order to address the need of transporting more infants multi child strollers are developed. The problem with the traditional multi stroller is that, if two adults have the desire to separate and travel to different locations with each adult accompanying one child, the stroller cannot be detached to form independent strollers.

Many attempts have been made for manufacturing multi strollers that can be detached from each other. One of such solution was to fasten removably the legs of a front and rear stroller using a pivotal locking device. This approach is complex and the parents do not get the view of the infant sitting in the front stroller. Moreover, this arrangement requires an additional pivotal locking device acting as a trailer to connect the strollers to each other.

Some other multi strollers utilize a fastening mechanism for releasably connecting independent strollers. However, this arrangement is also complex and requires manual effort for disconnecting and connecting the strollers.

Hence, it can be seen, that there is a need for a dual independent side-by-side stroller formed by connecting a plurality of independent strollers by aligning an attachment means. Further, the needed arrangement would be disconnected by pulling or pushing levers to detach the attachment means forming independent strollers. Moreover, the needed arrangement would be simple, economical, and would be easy to detach into independent strollers with minimal effort. Moreover, the needed arrangement would utilize a plurality of sets of folding and/or unfolding wheels that fold and unfold for connecting and disconnecting the strollers respectively.

### SUMMARY OF THE INVENTION

To minimize the limitations found in the prior art, and to minimize other limitations that will be apparent upon the reading of the specifications, the present invention provides a stroller formed by connecting a plurality of independent strollers for transporting at least one occupant. The stroller comprises a plurality of tubular frames having an upper frame portion and a lower frame portion, a plurality of seats attached between the upper frame portion and the lower frame portion. The upper frame portion is defined to form a handle bar and the plurality of seats being configured to support the at least one occupant. The stroller further comprises a wheel assembly being mounted on the lower frame portion, at least one attachment means arranged proximate the handle bar and a plurality of levers or push buttons fixed to the plurality of tubular frames proximate the handle bar. The wheel assembly comprises a plurality of sets of folding and/or unfolding wheels, a plurality of sets of front wheels and a plurality of sets of rear wheels. The attachment means is fixed at an opposing left and right sides of the plurality of tubular frames. The plurality of levers is pulled simultaneously to detach the attachment means thereby separating the plurality of independent strollers. The plurality of tubular frames is attached with each other by pushing the plurality of independent strollers and aligning at least one attachment means to define a central frame portion to form a dual independent side-by-side stroller.

In another aspect of the present invention, a method in accordance with the present invention is a method for connecting a plurality of independent strollers side-by-side to form a stroller for transporting at least one occupant, comprising of providing a plurality of independent strollers, pushing the plurality of independent strollers together and aligning at least one attachment means to define a central frame portion thereby folding a plurality of sets of folding and/or unfolding wheels. The present invention further comprises a method for separating a plurality of independent strollers for transporting at least one occupant, comprising of providing a plurality of independent strollers connected with at least one attachment means, pulling a plurality of levers simultaneously thereby detaching the attachment means and unfolding a plurality of sets of folding and/or unfolding wheels.

One objective of the invention is to provide a stroller formed by connecting a plurality of independent strollers for transporting at least one occupant.

Another objective of the invention is to provide a stroller that can be separated into a plurality of folding and/or unfolding independent strollers.

A third objective of the invention is to provide a stroller wherein at least one attachment means is adaptable to attach a plurality of independent strollers with each other and unlock plurality of independent strollers to form a dual independent side-by-side stroller.

Yet another objective of the invention is to provide a dual independent side-by-side stroller that is easy and convenient to use.

Still another objective of the invention is to provide a stroller that can be separated into a plurality of independent strollers, so that a plurality of individuals can accomplish.

These and other advantages and features of the present invention are described with specificity so as to make the present invention understandable to one of ordinary skill in the art.

### BRIEF DESCRIPTION OF THE DRAWINGS

Elements in the figures have not necessarily been drawn to scale in order to enhance their clarity and improve understanding of these various elements and embodiments of the invention. Furthermore, elements that are known to be common and well understood to those in the industry are not depicted in order to provide a clear view of the various embodiments of the invention, thus the drawings are generalized in form in the interest of clarity and conciseness.

FIG. 1 is a perspective view of the present invention showing a stroller by connecting a plurality of independent strollers with each other;

FIG. 2 is a front view of the present invention showing a plurality of sets of folding and/or unfolding wheels and a plurality of sets of rear wheels;

FIG. 3 is a perspective view of the stroller separated into a plurality of independent strollers; and

FIG. 4 is a rear view of the stroller showing a lower frame portion that supports the plurality of sets of rear wheels.

### DETAILED DESCRIPTION OF THE DRAWINGS

In the following discussion that addresses a number of embodiments and applications of the present invention, reference is made to the accompanying drawings that form a part hereof, and in which is shown by way of illustration specific embodiments in which the invention may be practiced. It is to be understood that other embodiments may be utilized and changes may be made without departing from the scope of the present invention.

Various inventive features are described below that can each be used independently of one another or in combination with other features. However, any single inventive feature may not address any of the problems discussed above or only address one of the problems discussed above. Further, one or more of the problems discussed above may not be fully addressed by any of the features described below.

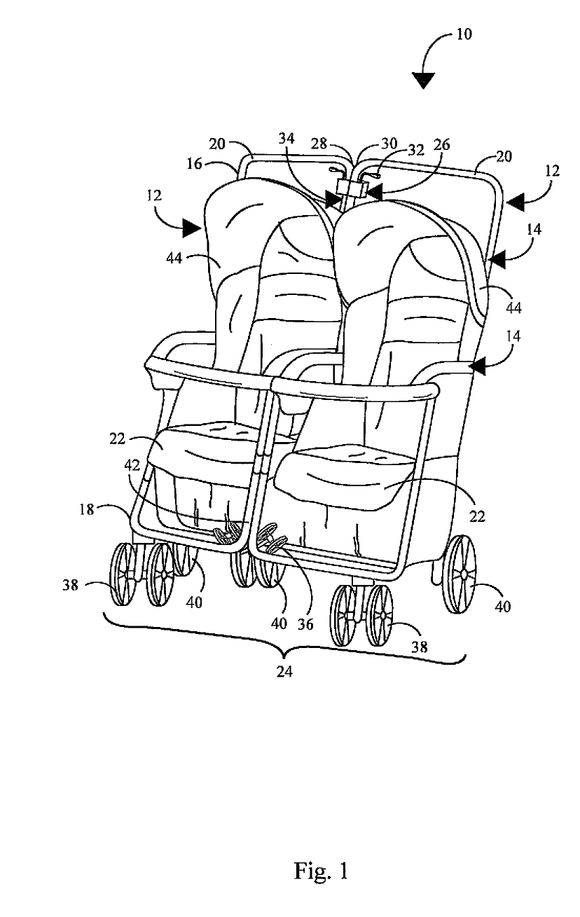

FIG. 1 is a perspective view of the present invention showing a stroller 10 by connecting a plurality of independent strollers 12 with each other. The stroller 10 comprises a plurality of tubular frames 14 having an upper frame portion 16 and a lower frame portion 18, a plurality of seats 22 attached between the upper frame portion 16 and the lower frame portion 18. The upper frame portion 16 is defined to form a handle bar 20 and the plurality of seats 22 is configured to support at least one occupant (not shown). The stroller 10 further comprises a wheel assembly 24 being mounted on the lower frame portion 18, at least one attachment means 26 arranged proximate the handle bar 20 and a plurality of levers 32 fixed to the plurality of tubular frames 14 proximate the handle bar 20. The attachment means 26 is fixed at an opposing left and right sides 28, 30 of the plurality of tubular frames 14. The plurality of levers 32 is pulled simultaneously to detach the attachment means 26 thereby separating the plurality of independent strollers 12. In the preferred embodiment, the plurality of tubular frames 14 is attached with each other by pushing the plurality of independent strollers 12 and aligning the attachment means 26 to define a central frame portion 34 to form a dual independent side-by-side stroller 10.

The plurality of tubular frames 14 may be integrally formed of materials such as carbon fiber, fiberglass, plastic, plastic composite material, aluminum, metal, metal alloy etc. The plurality of seats 22 may be integrally formed of materials such as cotton, synthetic material, cotton blend material, nylon, canvas, polyester, mesh, neoprene, foam etc. The plurality of seats 22 is attached to the plurality of tubular frames 14 by means that may be selected from the group consisting of screws, nuts and bolts, a metal mounting bracket, a plastic mounting bracket, a plastic composite material.

As shown in FIG. 1, the wheel assembly 24 comprises a plurality of sets of folding and/or unfolding wheels 36, a plurality of sets of front wheels 38 and a plurality of sets of rear wheels 40. The plurality of sets of folding and/or unfolding wheels 36 is fixed in a lower portion of the central frame portion 42. The stroller 10 further comprises a fabric cover 44 that covers the plurality of tubular frames 14 thereby providing comfort seating to the occupant (not shown). The fabric cover 44 may be integrally formed of a material such as nylon, canvas, neoprene, polyester, cotton etc. The attachment means 26 may be a clasp having a male and female locking mechanism. The clasp may be attached to the plurality of tubular frames 14 by means of screws or adhesives that may be glue.

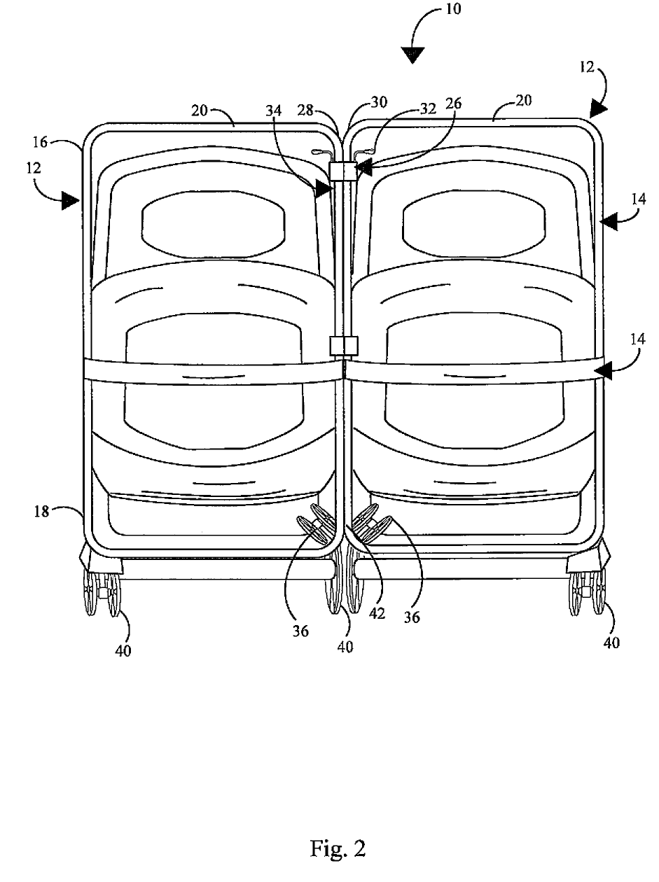

FIG. 2 is a front view of the present invention showing a plurality of sets of folding and/or unfolding wheels 36 and a plurality of sets of rear wheels 40. The plurality of independent strollers 12 is pushed together and the attachment means 26 are aligned thereby folding the plurality of sets of folding and/or unfolding wheels 36 to form the stroller 10. The plurality of sets of folding and/or unfolding wheels 36 in a lower portion of the central frame portion 42 retract when the plurality of independent strollers 12 connect. The plurality of independent strollers 12 is connected to form a side-by-side double stroller arrangement 10 that is adaptable to carry a plurality of occupants (not shown). The rear wheels 40 include a break (not shown) that can be mounted to a rear axle using a foot stomp (not shown). The front wheels 38 can be swiveled using means such as ball bearings, spacer or washer.

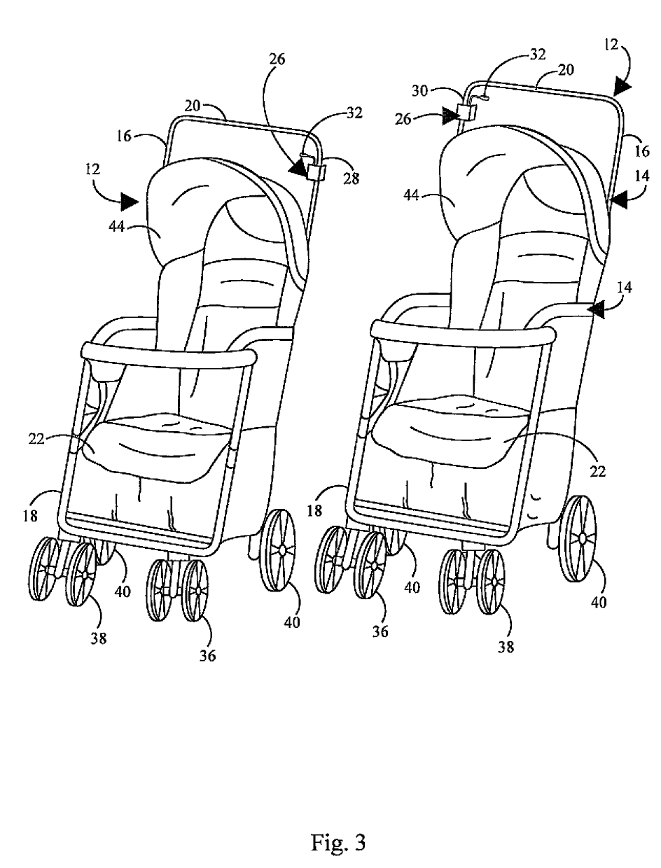

FIG. 3 is a perspective view of the stroller 10 separated into a plurality of independent strollers 12. The plurality of levers 32 is pulled simultaneously to detach the attachment means 26 thereby unfolding the plurality of sets of folding and/or unfolding wheels 36 and separating into the plurality of independent strollers 12. The plurality of levers 32 is pulled to unfold the plurality of sets of folding and/or unfolding wheels 36 by engaging an internal cable (not shown) in the plurality of tubular frames 14 connecting the plurality of levers 32 to a base of the plurality of sets of folding and/or unfolding wheels 36. The levers 32 is adaptable to be mounted on anywhere in the tubular frames 14. The plurality of levers 32 may be integrally formed of a materials such as carbon fiber, fiberglass, plastic, plastic composite material, aluminum, metal, metal alloy etc.

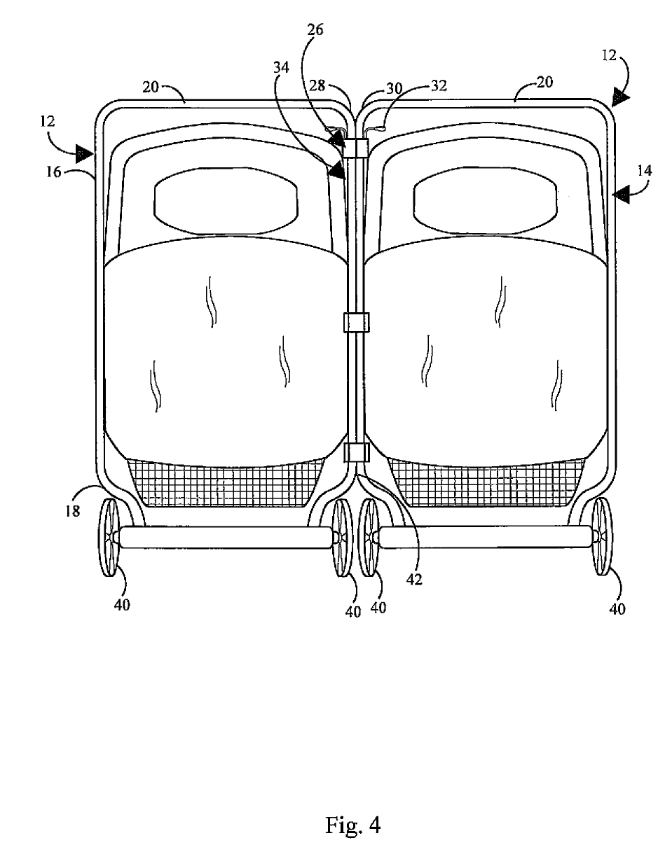

FIG. 4 is a rear view of the stroller 10 showing a lower frame portion 18 that supports the plurality of sets of rear wheels 40. The wheel assembly 24 is attached to the plurality of tubular frames 14 by means that may be selected from the group consisting of screws, metal axel, metal alloy axel, nuts and bolts, ball bearings. The wheel assembly 24 may integrally formed of a materials such as rubber, plastic, plastic composites etc. The plurality of sets of folding and/or unfolding wheels 36 is attached to a lower portion of the central frame portion 42 by means of a hinge, a metal hinge, a metal alloy hinge, hydraulics and the like. In the preferred embodiment, the wheel assembly 24 includes twelve wheels. Preferably, the plurality of sets of rear wheels 40 is attached to the tubular frame 14 by means of metal axel and the plurality of sets of front wheels 38 is attached to the tubular frame 14 by means of nuts and bolts.

In another embodiment, the stroller may comprise a plurality of food strays, a plurality of drink holders and a plurality of storage baskets. The plurality of food trays can be mounted on the frame by various means, preferably screws and can be made of materials such as molded plastic, composite plastic or fiberglass material. The drink holders can be made of materials such as plastic molded, composite, fiberglass etc. The drink holders may be cup holders that can be mounted anywhere on the frame, preferably handle bar. The storage baskets can be mounted on the rear backrest of the seats and/or underneath the seats by various means like buttons straps sewn in, glue hooks, brackets etc. The storage baskets can be made of materials such as cotton, synthetic, cotton blend material, nylon, canvas, polyester, mesh, neoprene etc. The stroller can also include attachment means having sliding lock mechanism with male and female components. While the present invention has been described in terms of specific embodiments, it is to be understood that the invention is not limited to the embodiments set forth herein.

The foregoing description of the preferred embodiment of the present invention has been presented for the purpose of illustration and description. It is not intended to be exhaustive or to limit the invention to the precise form disclosed. Many modifications and variations are possible in light of the above teachings. It is intended that the scope of the present invention not be limited by this detailed description, but by the claims and the equivalents to the claims appended hereto.

What is claimed is:

1. A stroller formed by connecting a plurality of independent strollers for transporting at least one occupant, the stroller comprising:
a plurality of tubular frames having an upper frame portion and a lower frame portion, the upper frame portion being defined to form a handle bar;
a plurality of seats attached between the upper frame portion and the lower frame portion, the seat being configured to support the occupant;
a wheel assembly being mounted on the lower frame portion;
at least one attachment means proximate the handle bar fixed at an opposing left and right sides of the plurality of tubular frames; and
a plurality of levers fixed to the plurality of tubular frames proximate the handle bar, the plurality of levers being pulled simultaneously to detach the attachment means thereby separating the plurality of independent strollers;
whereby the plurality of tubular frames is attached with each other by pushing the plurality of independent strollers and aligning the attachment means to define a central frame portion to form a dual independent side-by-side stroller.

2. The stroller of claim 1 wherein the wheel assembly comprises:
a plurality of sets of folding and/or unfolding wheels;
a plurality of sets of front wheels; and
a plurality of sets of rear wheels.

3. The stroller of claim 1 wherein the plurality of levers is pulled to detach the attachment means thereby unfolding the plurality of sets of folding and/or unfolding wheels and separating into the plurality of independent strollers.

4. The stroller of claim 1 wherein the plurality of independent strollers is pushed together and the attachment means are aligned thereby folding the plurality of sets of folding and/or unfolding wheels to form the stroller.

5. The stroller of claim 1 wherein the plurality of sets of folding and/or unfolding wheels in a lower portion of the central frame portion retract when the plurality of independent strollers are connected.

6. The stroller of claim 1 wherein the plurality of levers is pulled to unfold the plurality of sets of folding and/or unfolding wheels by engaging an internal cable in the plurality of tubular frames connecting the plurality of levers to a base of the plurality of sets of folding and/or unfolding wheels.

7. The stroller of claim 1 wherein at least one attachment means may be a clasp having a male and female locking mechanism.

8. The stroller of claim 7 wherein the clasp may be attached to the plurality of tubular frames by means of screws.

9. The stroller of claim 7 wherein the clasp may be attached to the plurality of tubular frames by means of adhesives.

10. The stroller of claim 9 wherein the adhesive may be glue.

11. The stroller of claim 1 wherein the wheel assembly is attached to the plurality of tubular frames by means that may be selected from the group consisting of screws, metal axel, metal alloy axel, nuts and bolts, ball bearings.

12. The stroller of claim 1 wherein the stroller further comprises a fabric cover that covers the plurality of tubular frames thereby providing comfort seating to the occupant.

13. The stroller of claim 12 wherein the fabric cover may be integrally formed of a material taken from the following set of materials: nylon, canvas, neoprene, polyester, cotton.

14. The stroller of claim 1 wherein the plurality of tubular frames may be integrally formed of a material taken from the following set of materials: carbon fiber, fiberglass, plastic, plastic composite material, aluminum, meal, metal alloy.

15. The stroller of claim 1 wherein the plurality of seats may be integrally formed of a material taken from the following set of materials: cotton, synthetic material, cotton blend material, nylon, canvas, polyester, mesh, neoprene, foam.

16. The stroller of claim 1 wherein the plurality of seats is attached to the plurality of tubular frames by means that may be selected from the group consisting of screws, nuts and bolts, a metal mounting bracket, a plastic mounting bracket, a plastic composite material.

17. The stroller of claim 1 wherein the wheel assembly may be integrally formed of a material taken from the following set of materials: rubber, plastic, plastic composites.

18. The stroller of claim 1 wherein the plurality of levers may be integrally formed of a material taken from the following set of materials: carbon fiber, fiberglass, plastic, plastic composite material, aluminum, metal, metal alloy.

19. The stroller of claim 2 wherein the plurality of sets of folding and/or unfolding wheels is attached to a lower portion of the central frame portion by means of a hinge, a metal hinge, a metal alloy hinge, hydraulics and the like.

20. A method for connecting a plurality of independent strollers side-by-side to form a stroller for transporting at least one occupant, comprising the steps of:
providing a plurality of independent strollers;
pushing the plurality of independent strollers together; and
aligning at least one attachment means to define a central frame portion thereby folding a plurality of sets of folding and/or unfolding wheels.

21. The method of claim 20 wherein at least one attachment means may be a clasp having a male and female locking mechanism.

22. The method of claim 20 wherein the plurality of sets of folding and/or unfolding wheels in a lower portion of the central frame portion retract when the plurality of independent strollers are connected.

23. A method for separating a plurality of independent strollers for transporting at least one occupant, comprising the steps of:
providing a plurality of independent strollers connected with at least one attachment means; and
pulling a plurality of levers simultaneously thereby detaching the attachment means and unfolding a plurality of sets of folding and/or unfolding wheels.

24. The method of claim 23 wherein at least one attachment means may be a clasp having a male and female locking mechanism.

25. The method of claim 23 wherein the plurality of levers lifts to unfold the plurality of sets of folding and/or unfolding wheels by engaging an internal cable in the plurality of tubular frames connecting the plurality of levers to a base of the plurality of sets of folding and/or unfolding wheels.
